(19) United States
(12) Patent Application Publication
(10) Pub. No.: US 2020/0042673 A1
(43) Pub. Date: Feb. 6, 2020

(54) LICENSE MANAGEMENT SYSTEM AND LICENSE MANAGEMENT METHOD

(71) Applicant: TOSHIBA TEC KABUSHIKI KAISHA, Tokyo (JP)

(72) Inventor: Kazuaki Kidokoro, Mishima (JP)

(21) Appl. No.: 16/052,920

(22) Filed: Aug. 2, 2018

(51) Int. Cl. G06F 21/10; G06F 21/62; G06F 3/12; H04N 1/44

(52) U.S. Cl. CPC G06F 21/105; G06F 21/6218; G06F 2221/0766; G06F 3/1229; H04N 1/4433; G06F 3/1219

(57) ABSTRACT

In accordance with an embodiment, a license management system installed in a multi-function peripheral is provided with an application or function for which confirmation of validity of a license by an external license management server which is the external device is required. The license management server sets a usage period if it is determined that a usage amount of the multi-function peripheral satisfies a permission condition. Within the usage period, the license of the desired application or function is set to be valid, and the desired application or function is set to be usable.

### FIELD

Embodiments described herein relate generally to a license management system mounted in a multi-function peripheral, and a license management method by the same.

### BACKGROUND

Conventionally, a multi-function peripheral uses a plurality of application software (hereinafter, referred to as applications) and a plurality of functions. Among those applications and the functions to be used, an application and a function requiring license agreement separately which are published by an external system are also contained. Depending on the license agreement, the multi-function peripheral accesses an external license management server connected to a network such as the Internet to receive valid confirmation of validity of a license every time the application is used.

### DESCRIPTION OF THE DRAWINGS

FIG. 1 is a diagram illustrating an example of a configuration of a multi-function peripheral according to a first embodiment;

FIG. 2 is a diagram illustrating an example of a configuration of an input section;

FIG. 3 is a diagram illustrating an example of measurement information collected by a measurement information section;

FIG. 4 is a flowchart depicting a method of managing applications and functions by a license management section according to the first embodiment;

FIG. 5 is a flowchart depicting a management method by the license management section when using applications and functions within a usage period according to the first embodiment;

FIG. 6 is a diagram illustrating an example of a configuration of a multi-function peripheral according to a second embodiment;

FIG. 7 is a diagram illustrating an example of a configuration of a recognition section;

FIG. 8 is a flowchart depicting a method of managing applications and functions by the license management section according to the second embodiment;

FIG. 9 is a flowchart depicting a management method by the license management section when using applications and functions within the usage period according to the second embodiment; and

FIG. 10 is a flowchart depicting a method of managing applications and functions by a license management section according to a third embodiment.

### DETAILED DESCRIPTION

Hereinafter, embodiments are described in detail with reference to the accompanying drawings.

(License Management System of Multi-Function Peripheral)

In accordance with an embodiment, a multi-function peripheral is provided with a license management system. The license management system comprises a storage section configured to store application software which includes a plurality of application software for realizing preset functions and for which confirmation of validity of a license by an external device is required; a license management section configured to include a measurement information section for measuring a usage amount of the multi-function peripheral and a usage period setting section for which a predetermined usage period is set when the usage amount exceeds a preset condition; and a control section configured to validate the license and permit usage for desired application software for which confirmation of validity of the license is required, in a state of being not electrically connected to an external device via the network if within the usage period.

(Concept of License Management System)

A multi-function peripheral is provided with application software (hereinafter, referred to as an application) and functions for at least performing basic operations. Furthermore, in order to realize additional functions for the purpose of convenience and an added value, a paid application permitted to be used under a license agreement can be provided or can be installed later to be executed.

For example, as the functions to be implemented, various functions including functions relating to printing such as usage of an additional special character font or an additional function of a printer driver (advanced color adjustment, print job management, etc.), management and delivery function of a document in cooperation with an external document server by using an OCR (Optical Character Recognition) function, and the like may be provided.

Mechanical structures for implementing paid applications and functions may be provided at the time of manufacture or shipment of the multi-function peripheral, or may be added after start of usage. The multi-function peripheral includes a license management system that gives usage permission to applications and functions for which confirmation of validity of the license is required.

If the external license management server which is an external device determines that a usage condition (or permission condition) according to a predetermined license agreement is satisfied, a usage period is set in the license management system. The license management system sets a license of a desired application or function to be valid to set the desired application or function to a usable state during the set usage period.

During the set usage period, the license management system permits a user of the multi-function peripheral to use the application or the function without accessing the license management server from the multi-function peripheral to confirm validity of the license. For example, a usage condition for validating the license refers to a condition in which measured usage amount such as the number of times of usage, the number of printed sheets, usage amount of ink or the like described later, is equal to or greater than a set amount.

As the usage amount, for example, a usage amount of the multi-function peripheral for one month before the start of usage, or an average usage amount per month in the usage amount of the multi-function peripheral over several months in the past, or the like may be provided according to various setting methods. Generally, if the multi-function peripheral is introduced according to a pay-for-usage lease agreement, the larger the usage amount is, the higher a usage fee paid to the lease source becomes. These agreements also include a case of using an application or a function for which confirmation of validity of license is required, and in this case, a user is charged for the usage fee according to a period in which the application or the function is used or the number of times of usage. The license management system permits the user, who pays a high usage fee, i.e., who uses the application or the function frequently, to use the application or the function for which confirmation of validity of license is required for free or at a low price within the set period.

### First Embodiment

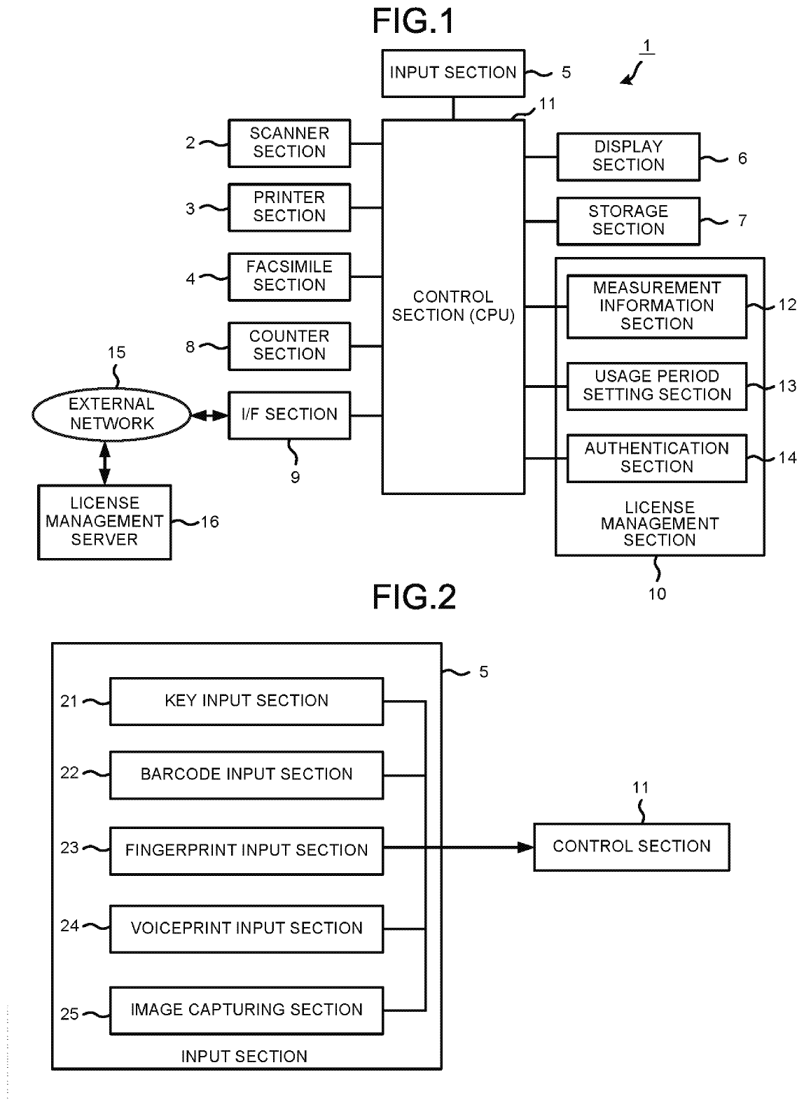

Hereinafter, a first embodiment of the multi-function peripheral 1 is described with reference to FIG. 1.

The multi-function peripheral 1 shown in FIG. 1 at least includes a scanner section 2, a printer section 3, a FAX (facsimile) section 4, an input section 5, a display section 6, a storage section 7, a counter section 8, an interface (I/F) section 9, and a license management section 10. These components are controlled by a control section (CPU) 11 to perform an arithmetic processing and determination as necessary. The control section 11 determines whether or not it is necessary to confirm validity of the license for the application or the function to be used.

For example, the scanner section 2 optically reads information such as images and characters printed on a medium using an image sensor, and converts the information to image information (or image signal) composed of an electric signal.

The printer section 3 is, for example, a laser printer or an inkjet printer. If the printer section 3 is the laser printer, a plurality of photoconductive drums each having a light source for forming an electrostatic latent image is arranged side by side, and one polygon mirror is arranged in the vicinity thereof. Each light source emits a laser beam based on an image signal of one color after color separation to the rotating polygon mirror. In order to guide the laser light from the polygon mirror to each photoconductive drum, a plurality of mirrors forming a scanning optical system is disposed. Each photoconductive drum transfers an image of each color onto an intermediate transfer belt. The intermediate transfer belt transfers an image onto an image receiving sheet. Thereafter, the image receiving sheet is subjected to a heat treatment at, for example, 100 degrees centigrade, and in this way, the image is fixed on the image receiving sheet. If an image signal is a color image for an image to be printed, the printer section 3 may also print a monochrome image in response to the image signal by performing setting or selection operation with the input section 5.

The facsimile section 4 only performs communication of image information which conforms to the G3 standard, the G4 standard, or the like. In the present embodiment, if the image information to be transmitted by facsimile is an image, a character or a symbol printed on a sheet, the image or the like is read by using the scanner section 2 to be converted to the image information. When the image information received by facsimile is printed on the image receiving sheet, the printer section 3 is used to print a monochrome image or a color image based on the image information on the image receiving sheet. Of course, even if the image information received by facsimile is the color image, a monochrome image based on the image information may be printed in the printer section 3 by performing setting or selection operation.

The input section 5 shown in FIG. 2 is operated by an operator to select a function to be used such as a facsimile communication function or a scanning function or to set usage conditions.

A key input section 21 is arranged on an upper surface or a side surface of a main body of the multi-function peripheral 1, and is composed of a plurality of function keys and numeric keys. A touch panel arranged on a screen surface of the display section 6 may be substituted for the key input section 21, or a combination of the touch panel with function keys or numeric keys may be arranged. Furthermore, the key input section 21 includes a slot or the like for installing a recording medium such as a USB or the like to write and read data.

For example, a barcode input section 22 reads a barcode recorded on an ID card or an employee ID card possessed by a user. A user touches a fingerprint sensor of a capacitance type with his/her finger, and in this way, a fingerprint input section 23 generates fingerprint identification information for identifying the user. A voiceprint input section 24 generates voiceprint identification information for identifying a user by using a microphone and a voice authentication application stored in the control section 11. Specifically, the user speaks a prescribed word towards the microphone, thereby recording his/her voice. By using the application, the voiceprint identification information based on the voice is generated.

An image capturing section 25 photographs a face of a user, extracts image data of the iris of eyes from a facial image, performs an arithmetic processing on an iris image, and generates iris identification information including features unique to each individual.

The display section 6 is, for example, a liquid crystal display, an organic EL (Electro-Luminescence) display, or the like. The display section 6 switches a screen corresponding to each function to be used to display information and setting information necessary for usage. For example, if the printer section 3 is used, the setting information is a printing color (color or monochrome), an image quality, the number of printed sheets, a size of the image receiving sheet, or the like. The setting information is selected and set by operating the input section 5.

The storage section 7 stores at least a program for driving the multi-function peripheral 1, an application provided for free, an application for which a license agreement is required, transmission destination information (customer information), usage history, operation guide information, and maintenance information. The information stored in the storage section 7 can be updated with the latest information. The application for which the license agreement is required is input from a license management server 16 which is the external device to the storage section 7. Alternatively, the application for which the license agreement is required may be stored in the storage section 7 by using the recording medium such as the USB or the like. Generally, a user needs to pay for the usage of the application for which the license agreement is required.

The counter section 8 receives the information relating to the number of times of usage described later each time the printer section 3, the scanner section 2 and the facsimile section 4 are used to generate accumulated data. It is also possible to provide information by dividing the accumulated data according to an arbitrary period.

The I/F section 9 has a communication function for data communication by being connected to various external networks 15 such as the Internet or a LAN (Local Area Network). The I/F section 9 also has a communication function to a telephone line, an ISDN (Integrated Services Digital Network), and the like. The I/F section 9 can be connected to the license management server 16 installed on the network such as the Internet or the LAN.

The license management system of the present embodiment includes at least the storage section 7, the counter section 8, the license management section 10 and the control section 11.

Next, the license management section 10 of the present embodiment is described in detail.

The license management section 10 sets a usage period if a preset usage condition including the usage amount of the multi-function peripheral 1 is satisfied in place of confirmation of validity of the license for the application the function, and enables the usage of the application or the function in the usage period. The license management server 16 sets the usage period of the application or the function based on the usage amount of the multi-function peripheral 1. The application or the function that can be used after confirmation of the usage period is determined by the license management server 16 or at the time of the license agreement. In principle, the application or the function that can be used during the usage period refers to an application or a function for which the confirmation of validity of the license is required at the time of usage. A condition under which the usage period is set is, for example, that the usage fee of the multi-function peripheral 1 paid by the user is equal to or greater than a preset amount.

Therefore, in the multi-function peripheral 1, there is no need to confirm validity of the license for the application or the function by the license management server 16 each time it is used.

The license management section 10 includes a measurement information section 12, a usage period setting section 13 and an authentication section 14.

The measurement information section 12 collects a plurality of the measurement information as the usage amount. The usage fee paid to the lease source is determined mainly according to the measurement information.

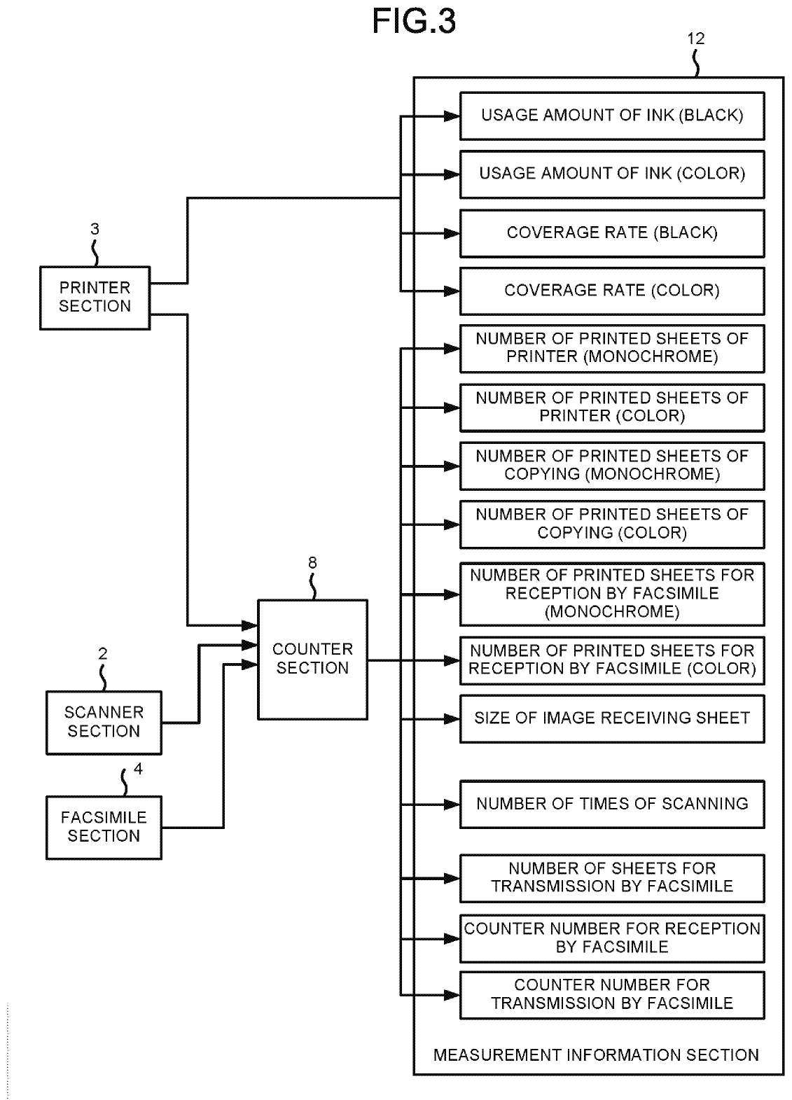

FIG. 3 shows an example of the measurement information collected by the measurement information section 12 according to the present embodiment. The measurement information refers to usage amount of the scanner section 2, the printer section 3, and the facsimile section 4, and roughly includes the number of printed sheets by monochrome printing, the number of printed sheets by color printing, the number of times of scanning, the number of times for reception and transmission by facsimile, a size of the image receiving sheet, usage amount of ink, and a coverage rate. As the detailed measurement information, the number of printed sheets (monochrome, color) of printer, the number of printed sheets (monochrome, color) of copying, the number of printed sheets (monochrome, color) for reception by facsimile, the number of times of scanning, the number of sheets for transmission by facsimile, the counter number for reception by facsimile, the counter number for transmission by facsimile, and the size of the image receiving sheet which are collected from the counter section 8 are provided. Besides, the usage amount of the ink (monochrome, color) collected from the printer section 3 and the coverage rate (monochrome, color) may also be provided as the measurement information. The size of the image receiving sheet is a size of the image receiving sheet used for printing, and the number of used sheets is gathered for each size.

A coverage rate is a rate of a printing area to a non-printing area on the image receiving sheet, and is calculated for each size of the image receiving sheet. Since an amount charged to the user is different in the monochrome printing using only black and the color printing, the number of printed sheets and the usage amount of the ink are handled separately for the monochrome printing using only black and the color printing. The number of times of scanning refers to the number of times the image receiving sheet is scanned by the scanner section 2 to generate image data from images and characters printed on the image receiving sheet.

The measurement information collected by the measurement information section 12 is read by the control section 11 at the time of receiving a request from the license management server 16 or in each set period, and is transmitted to the license management server 16 through the I/F section 9. The license management server 16 compares the received measurement information with preset permission conditions such as determination values (or threshold values) of the number of printed sheets, the usage amount of the ink, and the like. The determination value is appropriately set according to type and quantity of the application or the function that is permitted to be used, and the number of days (or months) of the usage period.

The usage period setting section 13 sets the usage period during which the application or the function can be used.

The license management server 16 sets the usage period for the usage period setting section 13 if the measurement information is equal to or greater than the determination value. The license management server 16 again acquires the measurement information collected by the measurement information section 12 by the final day of the usage period previously set, and then can automatically extend the usage period continuously if the permission condition is satisfied. Therefore, if the usage amount does not decrease, the user does not need to separately perform procedures for extending the period, which is convenient for the user.

The condition for setting the usage period may also include conclusion of a license agreement different from that of the function, such as periodic maintenance job or replacement of expendable parts in addition to the usage amount. In addition, if the multi-function peripheral 1 to be used is a high-speed model for performing a large amount of printing, or if the number of covenanted apparatuses that the user simultaneously uses is large, the above conditions may also contained as the permission conditions.

When starting to use the application or the function for which such a confirmation of validity of the license is required, based on the usage history before the start, for example, the average usage amount in several months before the usage start month, the setting of the usage period may be permitted. When starting to use the multi-function peripheral 1 newly introduced by the user, for example, the application or the function may be used for free in one month from the start of the use.

The usage period setting section 13 notifies the control section 11 of the usage period of the application or the function designated through the input section 5. If it is determined that it is within the usage period, the control section 11 enables the designated application or function to operate.

The application or function for which confirmation of the license is required may be restricted from being used by the user according to an individual (job type, job title, etc.), department to which the user belongs, or a project team.

The authentication section 14 authenticates whether or not the user has permission to use the application or the function when the application or the function whose usage is restricted is designated with the input section 5. As an authentication method, for example, it is confirmed whether the user is registered. The authentication section 14 registers at least one of an individual identification number (ID number) of a user, a password, an employee number, a department code number, fingerprint information, voiceprint information, and iris information as authentication means. Alternatively, a barcode or an IC chip attached to an employee ID card or a license card may be used.

As a procedure of authentication, the control section 11 instructs to acquire authentication data of the user through the input section 5 when notified from the input section 5 that the application or the function for which confirmation of the license is performed is used. The input section 5 acquires the authentication data of the user using any one of the input means described above and outputs it to the authentication section 14. The authentication section 14 authenticates whether or not the user is registered using the authentication data. The authentication section 14 notifies the control section 11 that the application or the function designated through the input section 5 can be used if the user is registered.

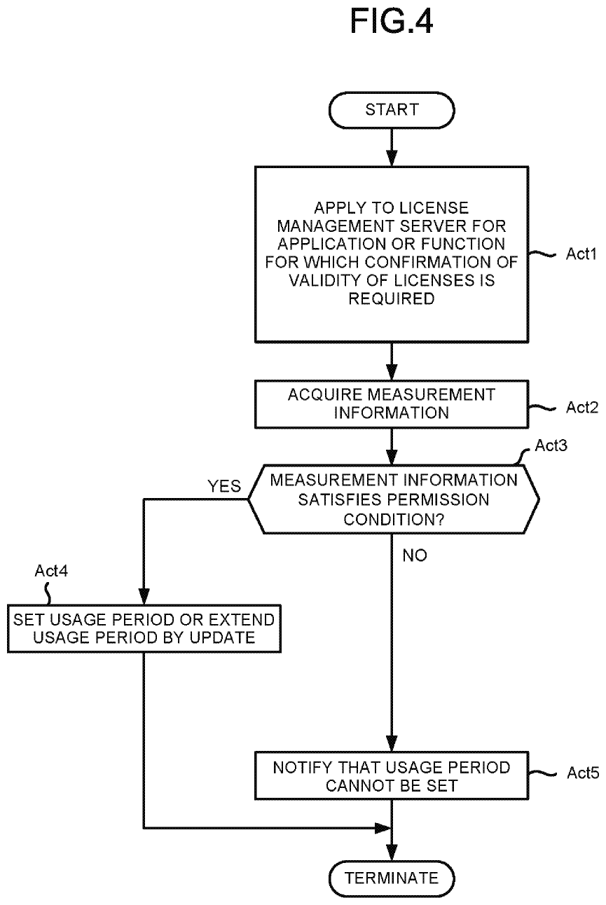

Next, with reference to the flowchart shown in FIG. 4, a method of managing the application or the function by the license management section 10 is described. Here, in the multi-function peripheral 1 according to the present embodiment, an application or a function for which confirmation of validity of the license is required is preliminarily provided, but the application or the function does not operate if the conformation of validity is not performed even if it is selected. In this example, instead of the confirmation of validity of the license, the setting of the usage period is used. New application or function is input from the license management server 16 which is the lease source of the multi-function peripheral 1 to the storage section 7. In this example, the multi-function peripheral 1 and the license management server 16 are connected via the Internet.

First, the user applies to the license management server 16 for the application or the function that he/she wants to use and for which confirmation of validity of the license is required (Act 1). The license management server 16 acquires the stored measurement information, such as the number of printed sheets, the usage amount of the ink or the like from the measurement information section 12 of the applied multi-function peripheral 1 from which the application is issued (Act 2). The measurement information may also be a usage history before the usage start month of the application or the function, for example, the average usage amount in several months before the usage start month. At this time, the license management server 16 determines whether or not the measurement information satisfies the permission condition (Act 3). In this determination, if the measurement information satisfies the permission condition, i.e., if the amount of the usage fee is equal to or greater than a set amount (Yes in Act 3), the license management server 16 sets the predetermined usage period for the usage period setting section 13 of the license management section 10 (Act 4). Incidentally, if the usage period of application or the function is continued in response to a request of the user, similarly, the measurement information collected by the measurement information section 12 is acquired again by the final day of the usage period set by the license management server 16, and if the measurement information satisfies the permission condition, the usage period may be continuously extended.

On the other hand, if the measurement information does not satisfy the permission condition (No in Act 3), the license management server 16 does not set the usage period for the usage period setting section 13, and notifies the control section 11 that the usage period is not set (Act 5). Specifically, the control section 11 displays that the usage period is not set, and also displays that the designated application or function cannot be used on the display section 6 to the user. Through these series of operations, the setting of the usage period during which the application or the function for which the confirmation of validity of the license is required can be used is completed for the license management section 10.

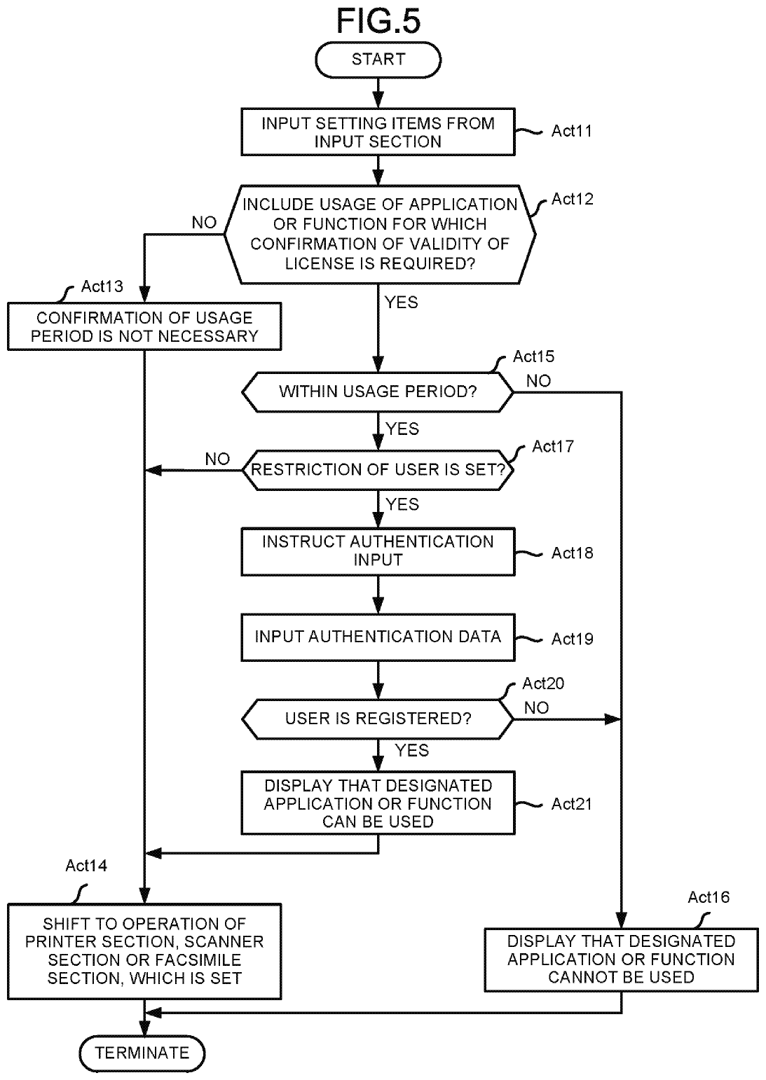

Next, with reference to the flowchart shown in FIG. 5, a management method by the license management section 10 when using the application or the function within the usage period is described.

First, the user operates the input section 5 to select the printer section 3, the scanner section 2, and the FAX section 4 to be used and to input necessary setting items (Act 11). For the setting items, the control section 11 determines whether or not the usage of the application and the function for which the confirmation of validity of the license is required is contained in the setting items (Act 12). If it is determined that the usage of the application and the function for which the confirmation of validity of the license is required is not contained in Act 12 (No in Act 12), the control section 11 determines that the confirmation of validity is unnecessary (Act 13). The control section 11 shifts to the operation of the printer section 3, the scanner section 2 or the facsimile section 4, which is set (Act 14).

On the other hand, if it is determined that the usage of the application or the function for which the confirmation of validity of the license is required is contained (Yes in Act 12), the control section 11 reads out the usage period from the usage period setting section 13 and determines whether or not the application or the function is within the usage period (Act 15). If it is determined that the application or function is not within the usage period in Act 15 (No in Act 15), it is determined that the application or the function cannot be used, and the control section 11 is notified. The control section 11 displays, on the display section 6, that the designated application or function cannot be used (Act 16). On the other hand, if the application or the function is within the usage period (Yes in Act 15), the control section 11 determines whether or not the restriction of the user is set for the designated application or function (Act 17).

If it is determined that no restriction is set for the user in Act 17 (No in Act 17), the control section 11 shifts to the operation of the printer section 3, the scanner section 2 or the facsimile section 4 which is set in Act 14 described above. On the other hand, if the restriction is set for the user (Yes in Act 17), the control section 11 displays a screen to for prompting input of the authentication data on the display section 6 to the user to instruct the authentication input to the input section 5 (Act 18).

In Act 18, if the user is requested to input the authentication data, the above authentication means such as the individual identification number (ID number) is input to the authentication section 14 as the authentication data through the input section 5 (Act 19).

The authentication section 14 authenticates whether or not the user is registered based on the authentication data (Act 20). If the authentication section 14 authenticates that the user is not registered (No in Act 20), the flow proceeds to the above-described processing in Act 16, and the control section 11 displays that the designated application or function cannot be used on the display section 6.

In Act 20, if the authentication section 14 authenticates that the user is registered (Yes in Act 20), the control section 11 determines that the user identified by the authentication data can use the designated application or function, and displays that the designated application or function can be used on the display section 6 (Act 21). The control section 11 returns to the above-mentioned processing in Act 14, and shifts to the operation of the printer section 3, the scanner section 2 or the facsimile section 4, which is set. The display indicating that the user can use the designated application or function in Act 21 may be omitted, and the control section 11 may directly shift to the processing in Act 14.

The multi-function peripheral 1 of the present embodiment described above can use the application or function for which the confirmation of validity of the license is required if the application or function is within the usage period, based on the usage period set by the external license management server.

The multi-function peripheral 1 determines the usage period in which the license is set to be valid instead of confirmation of the validity of the license performed by the external license management server, and manages the usage period for each multi-function peripheral 1, and thus, it is possible to reduce the delay in the communication processing by network communication, simplify labor and time required for access, and reduce the number of times of the communication.

Since the usage period of the application or the function is determined based on the usage amount of the multi-function peripheral 1, management operation becomes easy. Since the permission condition of the usage period is the usage amount, if the usage amount is not changed, the usage period of the application or the function is automatically extended, a separate procedure for extending the period is unnecessary, which is convenient for the user. It is possible to easily use the desired application or function even in a situation in which the communication environment is bad, such as there is no Internet, or the communication time required for network communication is long.

### Second Embodiment

Instead, the license management system of the multi-function peripheral 1 of the second embodiment carries out the confirmation of validity of the license of the application or the function designated in advance under the authority of the license management system during the set period. The substitution is carried out when it is determined by the external license management server that the permission condition according to the predetermined license agreement is satisfied.

In the first embodiment described above, by using the usage period in place of the confirmation of validity of the license of the application or the function to determine that the license is valid if the application or the function is within the usage period, the confirmation of validity of the substantial license may be not performed.

If it is determined by the external license management server that the permission condition according to the predetermined license agreement is satisfied, the license management system of the second embodiment carries out the confirmation of validity of the license of the application or the function designated in advance instead under the authorization of the license management system during the set period. During the set period, the license management system does not need to access the license management server to confirm validity of the license every time the application or the function is used. In other words, the multi-function peripheral 1 confirms validity of the license in a state of being not connected to the license management server, and if the license is valid, the multi-function peripheral 1 permits the user to use the application or the function.

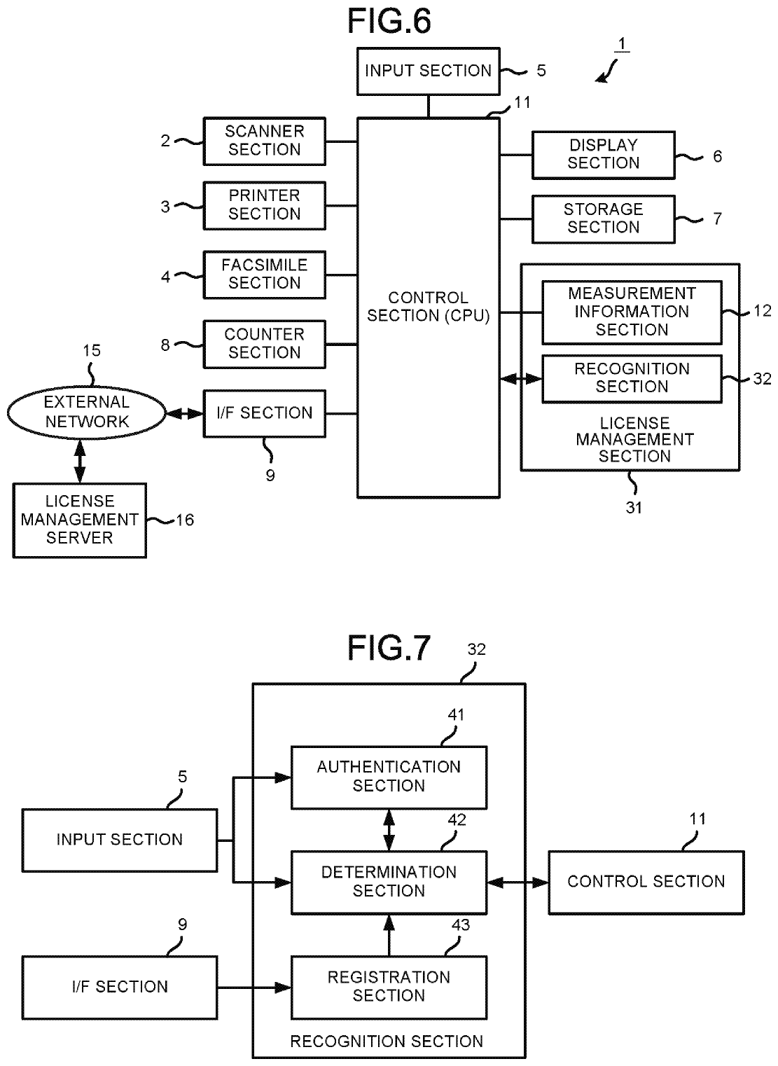

Hereinafter, the configuration of the multi-function peripheral 1 is described with reference to FIG. 6. In the following description, the components of the second embodiment are denoted with the same reference numerals as those of the above-described first embodiment, and a detailed description thereof is omitted. The multi-function peripheral 1 of the present embodiment differs from that of the first embodiment in the configuration of the license management section.

The multi-function peripheral 1 shown in FIG. 6 includes at least the scanner section 2, the printer section 3, the facsimile section 4, the input section 5, the display section 6, the storage section 7, the counter section 8, the I/F section 9, and a license management section 31. These components are controlled by the control section (CPU) 11 to perform an arithmetic processing and determination as necessary. Further, the control section 11 determines whether or not it is necessary to confirm validity of the license for the application or the function to be used. The license management system of the present embodiment includes at least the storage section 7, the counter section 8, the license management section 31 and the control section 11.

With reference to FIG. 7, the license management section 31 of the present embodiment is described in detail. FIG. 7 is a diagram illustrating an example of a configuration of a recognition section according to the second embodiment.

Instead of the license management server 16, the license management section 31 performs confirmation of the validity of the license for the paid application or function within the preset period. However, the application or the function, for which the confirmation of the validity of the license can be performed by the license management section 31 instead, is determined in the license management server 16 or at the time of license agreement.

Whether the license management section 31 performs the confirmation of the validity of the license instead is determined by the external license management server 16. As a condition for permitting the license management section 31 to perform the confirmation of the validity of the license instead, for example, the usage fee of the multi-function peripheral 1 paid by the user is equal to or greater than a preset amount. In other words, if the usage fee paid to the lease source is equal to or greater than the set amount, the license management section 31 can perform the confirmation of the validity of the license for the application or the function to be used instead of the license management server 16, and permits usage of the application or the function for free or at a low price.

Consequently, it is not necessary to perform the confirmation of validity of the license for the application or the function by the license management server 16 every time the application or the function is used. Thus, the number of times of the network communication between the license management server 16 and the license management section 31 is reduced. The desired paid application and function can be used even in a situation in which the communication environment is bad, such as there is no Internet or the communication time required for network communication is long.

The license management section 31 includes the measurement information section 12 and a recognition section 32.

The measurement information section 12 in the second embodiment is equivalent to the measurement information section shown in FIG. 3 described above. The measurement information section 12 collects a plurality of the measurement information as the usage amount. The usage fee paid to the lease source is determined mainly according to the measurement information. The measurement information collected in the measurement information section 12 is read by the control section 11 at the time of receiving request from the license management server 16 or in each set period and is sent to the license management server 16 through the I/F section 9.

The license management server 16 compares the received measurement information with a preset permission condition, for example, determination values (or threshold values) of the number of printed sheets, the usage amount of the ink, and the like. The determination value is appropriately set according to the application or the function permitted to be used. After starting the confirmation of validity of the license, if the measurement information is equal to or greater than the determination value, the license management server 16 can extend a substitution period so as to continue to confirm validity of the license for the license management section 31.

As described above, as another condition for permitting the confirmation of the validity by the license management section 31, in addition to the usage amount, that a license agreement in a large sum is concluded, that the multi-function peripheral 1 of an expensive high-level model is used, or that the number of covenanted apparatuses is large may be contained as permission conditions similarly. Furthermore, when starting to use the application or the function, the confirmation of validity of the license may be permitted based on the usage history before the start, for example, the average usage amount in several months before the use start month. When the user starts to use the multi-function peripheral 1 newly introduced, for example, the application or the function may be used for free in one month since the start of usage.

Next, the recognition section 32 includes an authentication section 41, a determination section 42 and a registration section 43.

There is a case in which the application or the function for which the confirmation of the validity of the license is required may be restricted from being used by the user according to an individual (job type, job title, etc.), department to which the user belongs, or a project team. The application or the function whose usage is restricted requires authentication of a user by the authentication section 41.

The authentication section 41 authenticates whether or not the user is registered, similarly to the above authentication section 14. The authentication section 41 registers at least one of the individual identification number (ID number) of the user, the password, the employee number, the department code number, the fingerprint information, the voiceprint information, and the iris information as the authentication means. Alternatively, the barcode or the IC chip attached to the employee ID card or the license card may also be used.

As a procedure of the authentication, the control section 11 instructs to acquire authentication data of the user through the input section 5 when notified from the input section 5 that the application or the function for which the confirmation of validity of the license is required is used. The input section 5 acquires the authentication data of the user using one of the above-mentioned input means and outputs it to the authentication section 41.

The authentication section 41 authenticates whether or not the user is registered using the authentication data. In this authentication, if the user is registered, the control section 11 determines that the application or the function designated with the input section 5 can be used.

The registration section 43 registers the identification number (or license number) of the application or the function for which the confirmation of validity is performed by the license management section 31. At the same time, the registration section 43 registers a period during which the confirmation of validity can be performed by the license management section 31 instead, i.e., the substitution period for each application or function. The substitution period is set by the license management server 16 through the I/F section 9. Different identification numbers are assigned to the applications or the functions. It is also possible to register the identification number and the substitution period of the application or the function for which confirmation of validity is performed by using the recording medium such as the USB or the like without using the external network 15.

The control section 11 determines whether or not the confirmation of validity of the license is necessary for the application or the function designated through the input section 5. The determination section 42 determines whether or not the license of the application or the function is valid.

If the control section 11 determines that the confirmation of validity of the license is necessary, the control section 11 instructs the determination section 42 to confirm whether or not the license of the application or the function is valid. If the confirmation of validity of the license of the application or the function is not necessary, the application or the function can operate without any changes without involving the license management section 31.

The determination section 42 compares the identification number assigned to the application or the function with the identification number registered in the registration section 43 if it is within the substitution period. The determination section 42 determines that the license is valid if the identification number assigned to the application or the function is registered. If the determination section 42 determines that the license is valid, the authentication section 41 described later authenticates whether or not the user is a registrant who can use the application or the function.

The determination section 42 notifies the control section 11 that the license is valid if the user can use the application or the function. Contrarily, if the identification number assigned to the application or the function is not registered, the determination section 42 determines that the license is not valid. The determination section 42 notifies the control section 11 that the license is not valid. The control section 11 displays that the designated application or function cannot be used on the display section 6 without enabling the application or the function to operate.

As described above, if it is determined that the license is valid, the determination section 42 determines whether or not the user is restricted for the application or the function. The determination section 42 notifies the control section 11 and the authentication section 41 that the user is restricted.

Upon receiving the notification that the user is restricted, the control section 11 displays a guide for prompting the user to perform an input operation for authentication on the display section 6. The authentication data of the user is transmitted from the input section 5 to the authentication section 41. The authentication section 41 authenticates whether or not the input authentication data of the user is registered. If the authentication data is registered, the authentication section 41 notifies the determination section 42 that the user is registered. Upon receiving the notification that the user is registered, the determination section 42 notifies the control section 11 that the license is valid. Contrarily, if the user is not registered, the authentication section 41 notifies the determination section 42 that the user is not registered. The determination section 42 notifies the control section 11 that the user who performs the input operation cannot use the application or the function. The control section 11 displays that the designated application or function cannot be used on the display section 6.

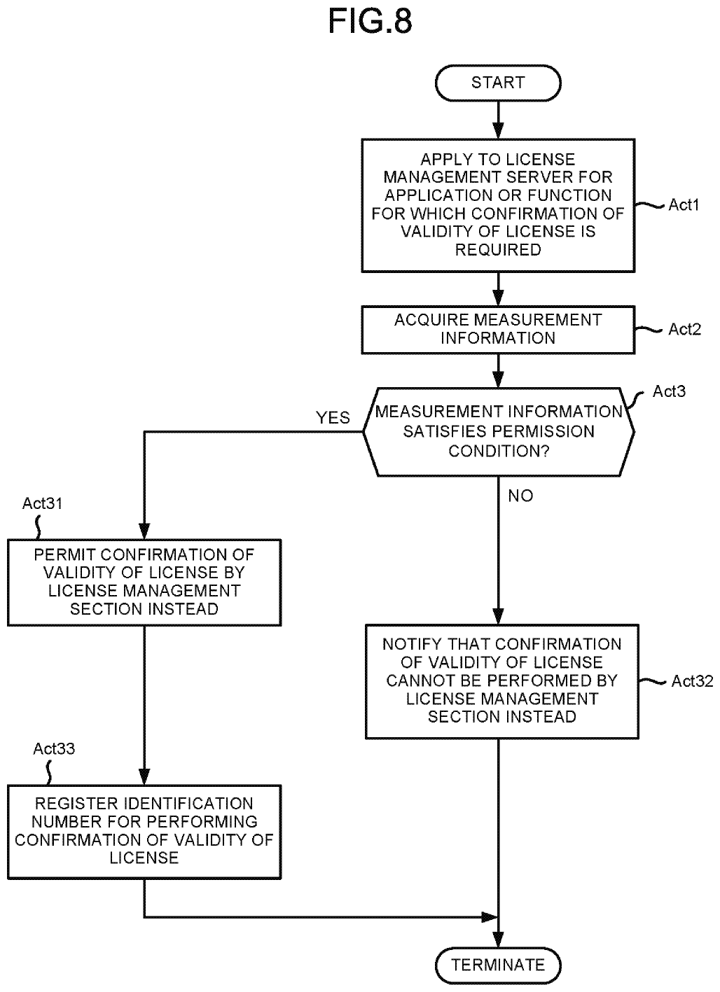

Next, with reference to the flowchart shown in FIG. 8, the setting for executing the confirmation of the validity of the license by the license management section 31 instead is described. In the following description, the same reference numerals are assigned to the same processing steps as those shown in FIG. 4, and the detailed description thereof is simplified.

Here, in the multi-function peripheral 1 according to the present embodiment, the application or the function for which the confirmation of validity of the license is required is preliminarily provided; however, even if it is selected, if the confirmation of the validity is not performed, the application or the function cannot be used. New application or function is input to the storage section 7 from the license management server 16 which is the lease source of the multi-function peripheral 1.

First, the setting for performing confirmation of validity of the license by the license management section 31 instead is described. In this example, the multi-function peripheral 1 and the license management server 16 are connected via the Internet.

The user applies to the license management server 16 for an application or a function that he/she wants to use and for which the confirmation of validity of the license is required (Act 1). The license management server 16 acquires the stored measurement information, such as the above-described number of printed sheets, usage amount of the ink, etc. from the measurement information section 12 of the applied multi-function peripheral 1 (Act 2). The measurement information may be the usage history before the usage start month of the application or the function, for example, the average usage amount in several months before the usage start month. At this time, the license management server 16 determines whether or not the measurement information satisfies the permission condition (Act 3). In this determination, if the measurement information satisfies the permission condition, i.e., if the amount of the usage fee is equal to or greater than the set amount (Yes in Act 3), the license management server 16 permits the license management section 31 to perform the confirmation of validity of the license instead within a predetermined period (Act 31). In accordance with such permission, the license management server 16 registers the identification number assigned to the application or the function for which the confirmation of the validity of the license is performed in the registration section 43 (Act 33). If the measurement information does not satisfy the permission condition (No in Act 3), the license management server 16 notifies the license management section 31 that the license management section 31 cannot perform the confirmation of validity of the licenses instead (Act 32). Through these series of operations, the setting for performing the confirmation of validity of the license by the license management section 31 instead is completed.

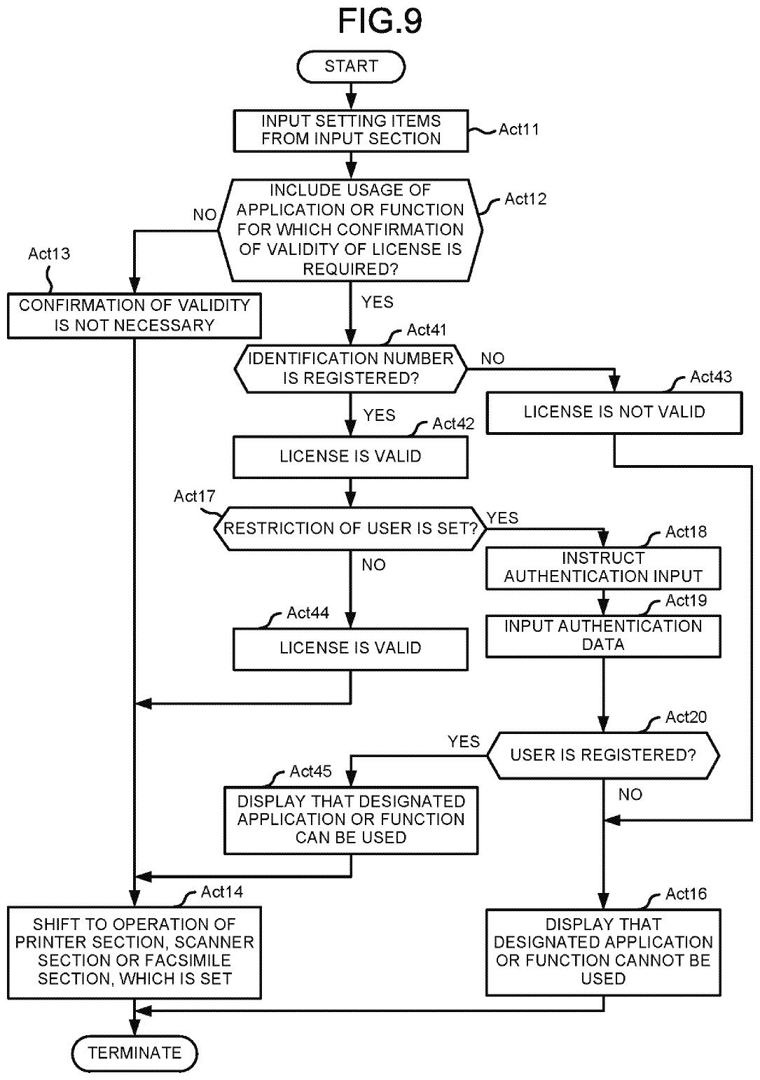

Next, with reference to the flowchart shown in FIG. 9, the flow of the confirmation of validity of the license by the license management section 31 is described.

First, the user operates the input section 5 to select the printer section 3, the scanner section 2, or the facsimile section 4 to be used and inputs necessary setting items (Act 11). For the setting items, the control section 11 determines whether or not the usage of the application or the function for which the confirmation of validity of the license is required is contained in the setting items (Act 12). If it is determined that the usage of the application or the function for which the confirmation of validity of the license is required is not contained (No in Act 12), the control section 11 is notified that the confirmation of validity is unnecessary (Act 13). The control section 11 shifts to the operation of the printer section 3, the scanner section 2 or the facsimile section 4, which is set (Act 14).

On the other hand, if it is determined that the usage of the application or the function for which the confirmation of validity of the license is required is contained (Yes in Act 12), the determination section 42 confirms the validity of the license. First, the determination section 42 determines whether or not the identification number assigned to the application or the function designated with the input section 5 is registered in the registration section 43 (Act 41) as described above. If the identification number assigned to the application or the function is not registered (No in Act 41), the determination section 42 determines that the license is not valid (Act 43), and notifies the control section 11 that the license is not valid. The control section 11 displays that the designated application or function cannot be used on the display section 6 without operating the application or the function (Act 16). Contrarily, if the identification number assigned to the application or the function is registered (Yes in Act 41), the determination section 42 determines that the license is valid (Act 42).

Next, the determination section 42 determines whether or not the restriction of the user is set for the designated application or function (Act 17). If the restriction is set for the user (Yes in Act 17), the determination section 42 notifies the control section 11 that the user is restricted. The control section 11 displays a screen on the display section 6 for promoting input of the authentication data, and instructs the input of the authentication data to the input section 5 (Act 18). Contrarily, if the restriction of the user is not set (No in Act 17), the control section 11 is notified that the license is valid (Act 44). The control section 11 shifts to the processing in Act 14 as described above to execute the operation the printer section 3, the scanner section 2 or the facsimile section 4, which is not set.

If the user is requested to input the authentication data in Act 18, the above authentication means such as the individual identification number (ID number) is input to the authentication section 14 as the authentication data through the input section 5 (Act 19).

The authentication section 41 determines whether or not the user is registered based on the authentication data (Act 20). If the authentication section 41 authenticates that the user is not registered (No in Act 20), the determination section 42 determines that the user identified by the authentication data cannot use the designated application or function, and notifies the control section 11. Then, the control section 11 shifts to the processing in Act 16, and displays that the designated application or function cannot be used on the display section 6.

If the authentication section 41 authenticates that the user is registered (Yes in Act 20), the determination section 42 determines that the user identified by the authentication data can use the designated application or function, and notifies the control section 11 (Act 45). The control section 11 returns to the above-mentioned processing in Act 14, and shifts to the operation of the printer section 3, the scanner section 2 or the facsimile section 4, which is set.

### Third Embodiment

The license management system of the multi-function peripheral 1 of the third embodiment is within the valid period in a period in which the license is set for an application or a function previously designated, and during the valid period, the license management system manages the application or the function without confirmation. In other words, the multi-function peripheral 1 can use the application or the function without making an inquiry to the external license management server if a preset determination condition is satisfied. The multi-function peripheral 1 of the third embodiment may have the same configuration as that of the second embodiment shown in FIG. 6 and FIG. 7 described above. Here, in the multi-function peripheral 1 according to the third embodiment, the application or the function for which the confirmation of validity of the license is required is preliminarily provided; however, even if it is selected, if the confirmation of the validity is not performed, the application or the function cannot be used.

In the authentication section 41, a function usage determination condition for the application or the function to be used is set. The function usage determination condition is set or changed, for example, by the external license management server 16 or a maintenance person of the multi-function peripheral 1.

As an example of the function to be used and the function usage determination condition, there is provided

1) Usage of paid font—the number of printed sheets in one month in the past is 1000 or more (however, it may be different depending on the monochrome printing and the color printing),

2) Usage of OCR function—the number of printed sheets by the color printing in three months in the past is 500 or more,

3) Usage of an application A—10 or more multi-function peripherals 1 are managed by the same management company on the same network, and the like.

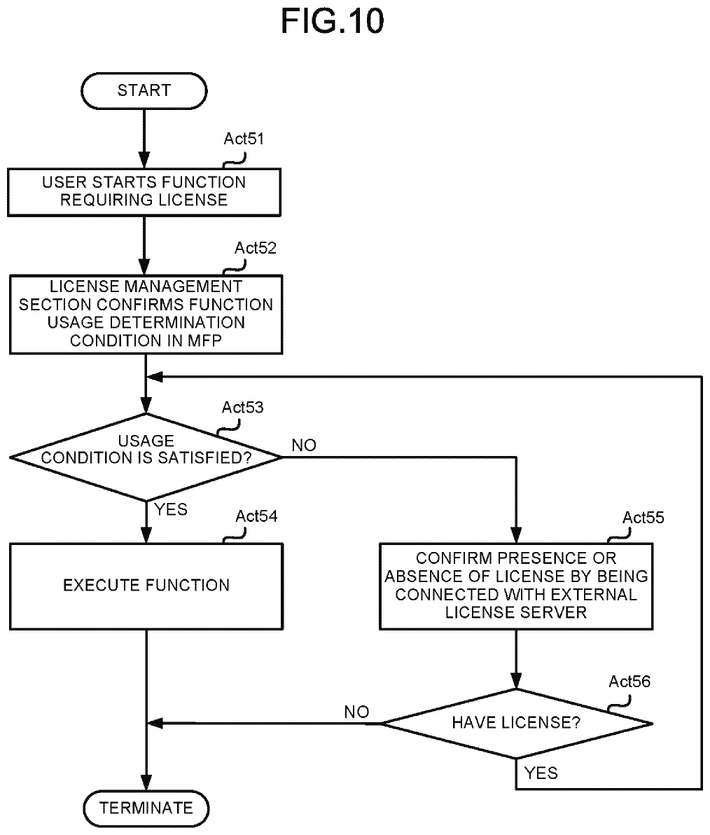

With reference to the flowchart shown in FIG. 10, a method of managing the application or the function by the license management section 10 is described.

First, the user operates the input section 5 to select the printer section 3, the scanner section 2 or the facsimile section 4 to be used, designates a function for which confirmation of validity of the license is required, and starts using the function (Act 51).

The license management section 31 confirms the function usage determination condition set in the multi-function peripheral 1 (Act 52). Specifically, the recognition section 32 of the license management section 31 reads the above function usage determination condition from the authentication section 41 into the determination section 42, and reads the measurement information corresponding to the function usage determination condition from the measurement information section 12.

The determination section 42 determines whether or not the measurement information, i.e., the usage amount satisfies the function usage determination condition (Act 53). In Act 53, if the usage amount satisfies the function usage determination condition (Yes in Act 53), the control section 11 executes the designated function without making an inquiry to the external license manager server 16 (Act 54). On the other hand, if it is determined in Act 53 that the usage amount does not satisfy the function usage determination condition (No in Act 53), the control section 11 is connected to the external license management server 16 to confirm the presence or absence of the license (Act 55). At this time, it is confirmed whether there is the license (Act 56). If there is the license (Yes in Act 56), the control section 11 returns to the processing in Act 53 and determines that the function usage determination condition is satisfied. On the other hand, if there is no license (No in Act 56), it is determined that the function usage determination condition is not satisfied, and that the designated application or function cannot be used is displayed on the display section 6. The processing in Act 55 is not indispensable, and it is possible to use the multi-function peripheral 1 even if the multi-function peripheral 1 is not connected to the external license management server 16 via the network.

According to the present embodiment, the license confirmation is performed based on whether the function usage determination condition set in the multi-function peripheral 1 is satisfied, and the desired function or application for which the confirmation of the license is required can be used. Since the input setting and the change of the function usage determination condition can be performed by the maintenance person, the multi-function peripheral 1 of the present embodiment can be used even in a state in which there is no network.

The multi-function peripheral 1 of the present embodiment described above uses the application or the function, which is managed by the external license management server and for which the confirmation of validity of the license is required. The multi-function peripheral 1 carries out the confirmation of the validity of the license which is performed by the external license management server instead alone, thereby reducing delay in the processing by the network communication or the time and labor required for access. With the permission for performing confirmation of validity of the access by the multi-function peripheral 1 instead, since the usage and the usage period of the desired application or function are determined according to the usage amount of the multi-function peripheral 1, the management operation becomes easy. Since the permission of the confirmation of validity of the license by the multi-function peripheral 1 instead is the usage amount, the usage period of the application or the function is easily extended, which is convenient for the user.

While certain embodiments have been described, these embodiments have been presented by way of example only, and are not intended to limit the scope of invention. Indeed, the novel apparatus and methods described herein may be embodied in a variety of other forms; furthermore, various omissions, substitutions and changes in the form of the apparatus and methods described herein may be made without departing from the spirit of the inventions. The accompanying claims and their equivalents are intended to cover such forms or modifications as would fall within the scope and spirit of the inventions.

What is claimed is:

1. A license management system installed in a multi-function peripheral, comprising
a storage section configured to store application software which includes application software for realizing one or more preset functions and for which confirmation of validity of a license by an external device is required;
a license management section comprising a measurement information section for measuring a usage amount of the multi-function peripheral and a usage period setting section for which a predetermined usage period is set when the usage amount exceeds a preset condition; and
a control section configured to validate the license and permit usage of desired application software for which confirmation of validity of the license is required, in a state of being not electrically connected to an external device via the network if within the usage period.

2. The license management system according to claim 1, wherein
the measurement information section measures information including one or more of a number of printed sheets by a monochrome printing, a number of printed sheets by a color printing, a number of times of scanning, a number of times of transmission and reception of a facsimile, a size of an image receiving sheet, a usage amount of ink, and a coverage rate as usage amount.

3. The license management system according to claim 1, wherein
the external device provides the predetermined usage period in the license management section when the usage amount exceeds the preset condition.

4. The license management system according to claim 1, wherein
the usage amount measured by the measurement information section is a usage amount of the multi-function peripheral in one month before the start of usage or an average usage amount corresponding to one month in usage amount of the multi-function peripheral over several months before the start of usage.

5. The license management system according to claim 1, further comprising:
a display section provided in the multi-function peripheral, wherein
the license management section displays by the display section a notification indicating that a function can be used for the function for which a license is validated, and displays by the display section a notification indicating that a function cannot be used for the function for which the license is not validated on the display section.

6. The license management system according to claim 1, wherein
the license management section includes an authentication section for authenticating a user who can use the application software and the function when usage of the application software and the function whose usage is restricted is instructed among the application software and the function for which confirmation of validity of the license is required.

7. The license management system according to claim 1, wherein
the multi-function peripheral comprises at least a printer section, a scanner section, and a facsimile section, wherein
the usage amount includes one or more of a number of printed sheets by a monochrome printing, a number of printed sheets by a color printing, a number of times of scanning, a number of times of transmission and reception of a facsimile, a size of an image receiving sheet, a usage amount of ink, and a coverage rate, which are counted according to usage of the printer section, the scanner section, and the facsimile section.

8. A license management system installed in a multi-function peripheral, comprising:
a storage section configured to store application software which includes application software for realizing one or more preset functions and for which confirmation of validity of a license by an external device is required;
a license management section comprising a measurement information section for measuring a usage amount of the multi-function peripheral, and a recognition section for which a substitution period in which confirmation of validity of a license which is performed by the external device is set when the usage amount exceeds a preset condition; and
a control section configured to perform confirmation of validity of the license for the application software desired to be used in a state of being not connected to the external device if within the substitution period.

9. The license management system according to claim 8, wherein
the measurement information section measures information including one or more of a number of printed sheets by a monochrome printing, a number of printed sheets by a color printing, a number of times of scanning, a number of times of transmission and reception of a facsimile, a size of an image receiving sheet, a usage amount of ink, and a coverage rate as usage amount.

10. The license management system according to claim 8, further comprising:
a display section provided in the multi-function peripheral, wherein
the license management section displays by the display section a notification indicating that a function can be used for the function for which a license is validated, and displays by the display section a notification indicating that a function cannot be used for the function for which the license is not validated on the display section.

11. The license management system according to claim 8, wherein
the license management section includes an authentication section for authenticating a user who can use the application software and the function when usage of the application software and the function whose usage is restricted is instructed among the application software and the function for which confirmation of validity of the license is required.

12. A license management system installed in a multi-function peripheral, comprising:
a storage section configured to store application software which includes application software for realizing one or more preset functions;
a license management section comprising a measurement information section for measuring a usage amount of the multi-function peripheral, an authentication section for which a function usage determination condition for executing the application software is set to be rewritable, and a determination section configured to determine whether or not the usage amount satisfies the function usage determination condition; and
a control section configured to execute the application software desired to be used if the usage amount satisfies the function usage determination condition.

13. The license management system according to claim 12, wherein
the measurement information section measures information including one or more of a number of printed sheets by a monochrome printing, a number of printed sheets by a color printing, a number of times of scanning, a number of times of transmission and reception of a facsimile, a size of an image receiving sheet, a usage amount of ink, and a coverage rate as usage amount.

14. The license management system according to claim 12, further comprising:
a display section provided in the multi-function peripheral, wherein
the license management section displays by the display section a notification indicating that a function can be used for the function for which a license is validated, and displays by the display section a notification indicating that a function cannot be used for the function for which the license is not validated on the display section.

15. The license management system according to claim 12, wherein
the license management section includes an authentication section for authenticating a user who can use the application software and the function when usage of the application software and the function whose usage is restricted is instructed among the application software and the function for which confirmation of validity of the license is required.

16. A license management method associated with a license management system installed in a multi-function peripheral, comprising:
setting a predetermined usage period when a usage amount of the multi-function peripheral exceeds a preset amount; and
validating a license of application software while not being connected to an external device within the usage period for the application software for realizing a preset function and for which confirmation of validity of the license by the external device is required.

17. The license management method according to claim 16, further comprising:
measuring information including one or more of a number of printed sheets by a monochrome printing, a number of printed sheets by a color printing, a number of times of scanning, a number of times of transmission and reception of a facsimile, a size of an image receiving sheet, a usage amount of ink, and a coverage rate as usage amount.

18. The license management method according to claim 16, further comprising:
displaying a notification indicating that a function can be used for the function for which a license is validated, and
displaying a notification indicating that a function cannot be used for the function for which the license is not validated.

19. A license management method associated with a license management system installed in a multi-function peripheral, comprising:
setting a predetermined substitution period for executing confirmation of validity of a license when a usage amount of the multi-function peripheral exceeds a preset amount; and
confirming validity of a license of application software while not being connected to an external device within the predetermined substitution period, and setting the application software to be usable when the license is valid for application software for realizing a preset function and for which confirmation of validity of the license by the external device is required.

20. The license management method according to claim 19, further comprising:
measuring information including one or more of a number of printed sheets by a monochrome printing, a number of printed sheets by a color printing, a number of times of scanning, a number of times of transmission and reception of a facsimile, a size of an image receiving sheet, a usage amount of ink, and a coverage rate as usage amount.
